(19) United States
(12) Patent Application Publication
(10) Pub. No.: US 2006/0069777 A1
(43) Pub. Date: Mar. 30, 2006

(54) Request message control method for using service and service providing system

(76) Inventors: Hideharu Kato, Yokohama (JP); Junichi Toyouchi, Sagamihara (JP); Tetsuo Tanaka, Yamato (JP); Nobutoshi Sagawa, Koganei (JP); Yoshiyuki Hirakawa, Ykohama (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 11/139,648

(22) Filed: May 31, 2005

(30) Foreign Application Priority Data
Sep. 3, 2004 (JP) 2004-256497

(51) Int. Cl. G06F 15/173

(52) U.S. Cl. 709/225

(57) ABSTRACT

In the case where Web service providers and Web service brokers are successively connected in a multistage manner to form a tree structure, with each of the Web service brokers relaying messages to be transmitted and received between a Web service requestor and the Web service providers, not only the performance, states, and configurations of Web service providers which are directly called by a Web service broker, but also those of Web service providers existing in a descendant direction of the tree structure, are made use of as information used to determine a Web service provider to which a request message should be transmitted.

### CLAIM OF PRIORITY

The present application claims priority form Japanese application P2004-256497 filed on Sep. 3, 2004, the content of which is hereby incorporated by reference into this application.

### FIELD OF THE INVENTION

The present invention relates to a request message control method for using services, and more particularly to a search method for searching for an optimum path of a request message used when the request message passes through a service broker that relays the request message.

### BACKGROUND OF THE INVENTION

In recent years, with the diffusion of the Internet as a background, Web services based on the XML (Extensible Markup Language) are being paid attention to.

In the Web services based on the XML, key technologies are SOAP (Simple Object Access Protocol), WSDL (Web Services Description Language), UDDI (Universal Description, Discovery and Integration). In a standard Web service model, a Web service broker plays an intermediary role between a Web service provider for providing Web services and a Web service requester that utilizes Web services. The Web service broker relays messages to be transmitted and received, and provides various kinds of functions.

This Web service broker provides functions including transformation of a message, signature and encryption, authentication and access control, and routing.

A message routing function of the Web service broker determines a destination of a request message by use of contents of the request message to be relayed, information about the performance of a destination Web service, and the like.

For example, the dynamic calling method for calling Web services disclosed in U.S. patent application 2003/0204622 (US 2003/0204622 A1) describes the use of a selection rule of selecting a called Web service on the basis of information including the availability, and QoS (Quality of Service), of the called Web service.

In the conventional Web services, statistical information such as the average response time acquired as a result of the measurement for a fixed period of time is used as QoS information (performance information) that is used to determine a request-message destination.

If the called Web service provider further calls another Web service provider (sub-Web service provider) to provide its own services, the performance of the called Web service provider depends on the performance, a state, a configuration, and the like, of the sub-Web service provider.

For example, what is assumed here is a situation in which the called Web service provider uses other Web services to provide its own services by distributing request messages to two sub-Web service providers having the same performance, and by calling the sub-Web service providers to which the request messages are distributed.

If one sub-Web service provider enters an unusable state for some reason or other, there is a possibility that the performance of a called Web service provider will become lower than the performance before entering the unusable state. However, according to the called Web-service determination method based on the statistical performance information, a request message may be transmitted to a Web service provider where there is a possibility that expected performance will not be achieved. To be more specific, the problem to be solved was that if a configuration of the system or the situation changed, an optimum path for transmitting a request message was not selected.

The present invention is devised to solve the above-mentioned problem. An object of the present invention is to provide a request message control method by which a change in performance of a called Web service provider, which is caused by a change in state, a change in configuration, and the like, of sub-Web service providers of the called Web service provider, is immediately coped with, and an optimum path for utilizing services is selected, so that the performance, and the reliability, of the system as a whole can be improved.

### SUMMARY OF THE INVENTION

According to the present invention, not only performance information, state information, and configuration information, of a Web service provider to which a Web service broker directly transmits a request message, but also performance information, state information, and configuration information, of sub-Web service providers, are made use of as information used to determine a Web service provider to which a request message should be transmitted. In other words, according to the present invention, if Web service brokers and Web service providers are successively connected in a multistage manner to form a tree structure, a Web service provider to which a request message should be transmitted is determined by use of not only information about a Web service provider that is directly called by a Web service broker, but also information about Web service providers existing in a descendant direction of the tree structure.

According to the present invention, it is possible to provide a request message control method by which a change in performance of a called Web service provider, which is caused by a change in state, a change in configuration, and the like, of sub-Web service providers of the called Web service provider, is immediately coped with, and an optimum path for utilizing services is selected, so that the performance, and the reliability, of the system as a whole can be improved.

### BRIEF DESCRIPTION OF THE DRAWINGS

FIG. 1 is a diagram illustrating a configuration of a service providing system according to one embodiment of the present invention;

Reference numeral 102 denotes a Web service to which a Web service broker 101 directly transmits a request message;

Reference numeral 103 denotes a Web service to which a Web service broker 101 directly transmits a request message;

Reference numeral 104 denotes a Web service broker subordinate to the Web service broker 101;

Reference numeral 105 denotes a Web service to which a Web service broker 104 directly transmits a request message;

Reference numeral 106 denotes a Web service to which a Web service broker 104 directly transmits a request message;

Reference numeral 107 denotes a Web service broker subordinate to the Web service broker 101;

Reference numeral 108 denotes a Web service to which a Web service broker 107 directly transmits a request message;

Reference numeral 109 denotes a Web service to which a Web service broker 107 directly transmits a request message;

Reference numeral 110 denotes notification information transmitted from the Web service broker 104 to the Web service broker 101.

FIG. 2 includes diagrams illustrating how a Web service and a Web service broker are configured;

FIG. 3 is a diagram illustrating an example of higher-level broker management information 203;

FIG. 4 is a diagram illustrating an example of Web-service-broker information included in a request message;

FIG. 5 is a diagram illustrating an example of called Web-service endpoint information 213;

FIG. 6 is a diagram illustrating an example of called Web-service performance/state information 215;

FIG. 7 is a diagram illustrating an example of lower-level broker information 216;

FIG. 8 is a diagram illustrating an example of called Web-service performance/state information 217 of a lower-level broker;

FIG. 9 is a diagram illustrating an example of notification message between brokers;

FIG. 10 is a flowchart illustrating processing steps of a Web service;

FIG. 11 is a flowchart illustrating processing steps of a Web service broker (first part); and

FIG. 12 is a flowchart illustrating processing steps of the Web service broker (second part).

### DESCRIPTION OF THE PREFERRED EMBODIMENTS

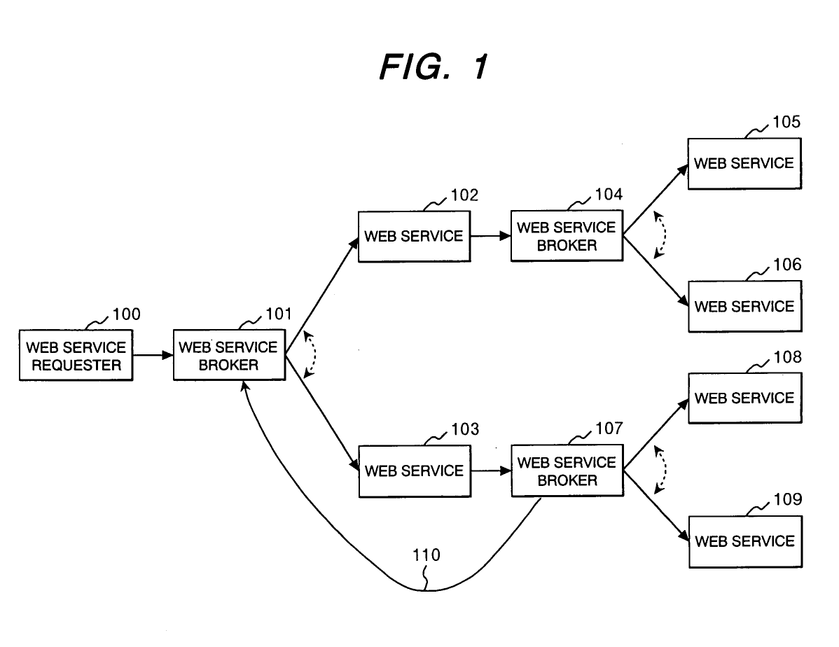

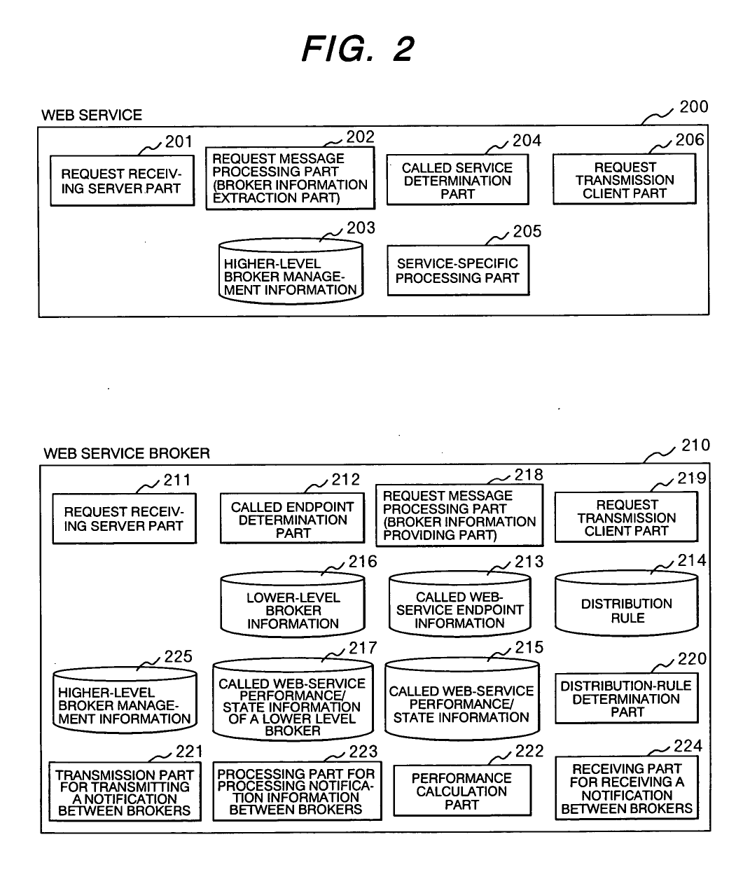

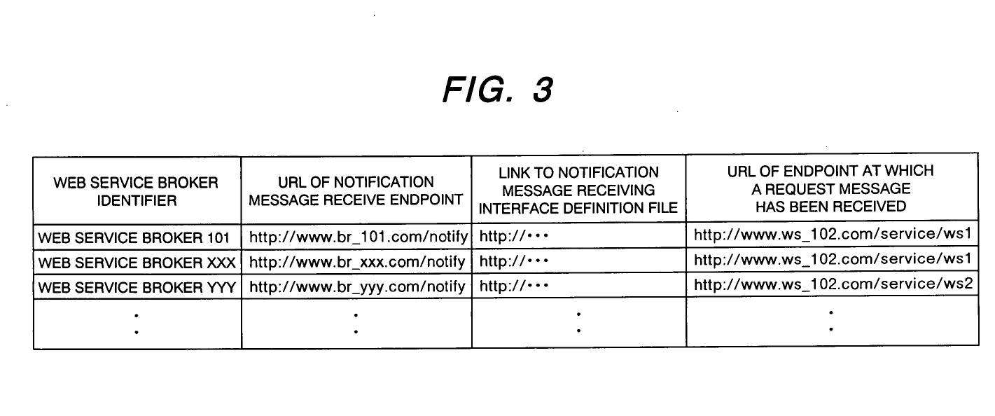

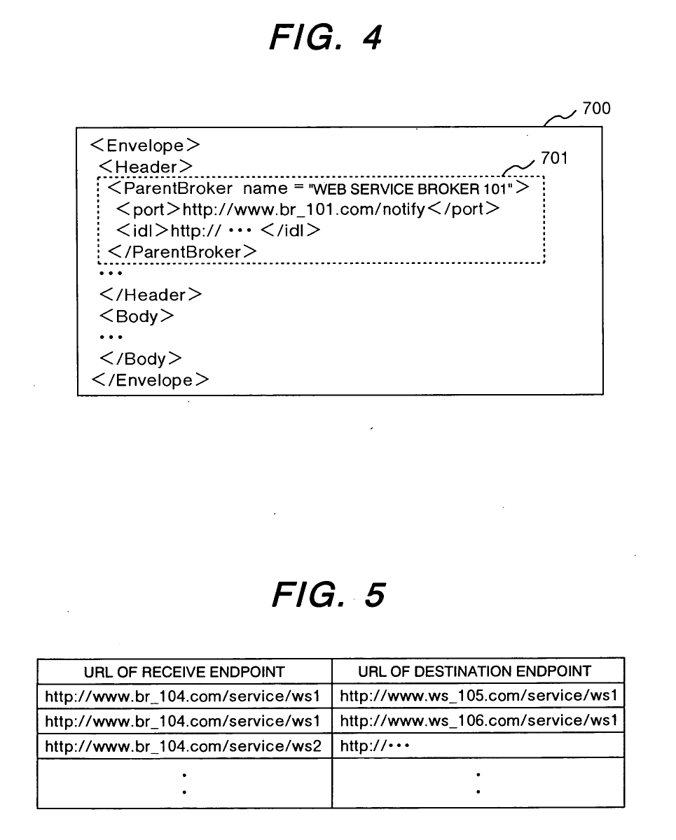

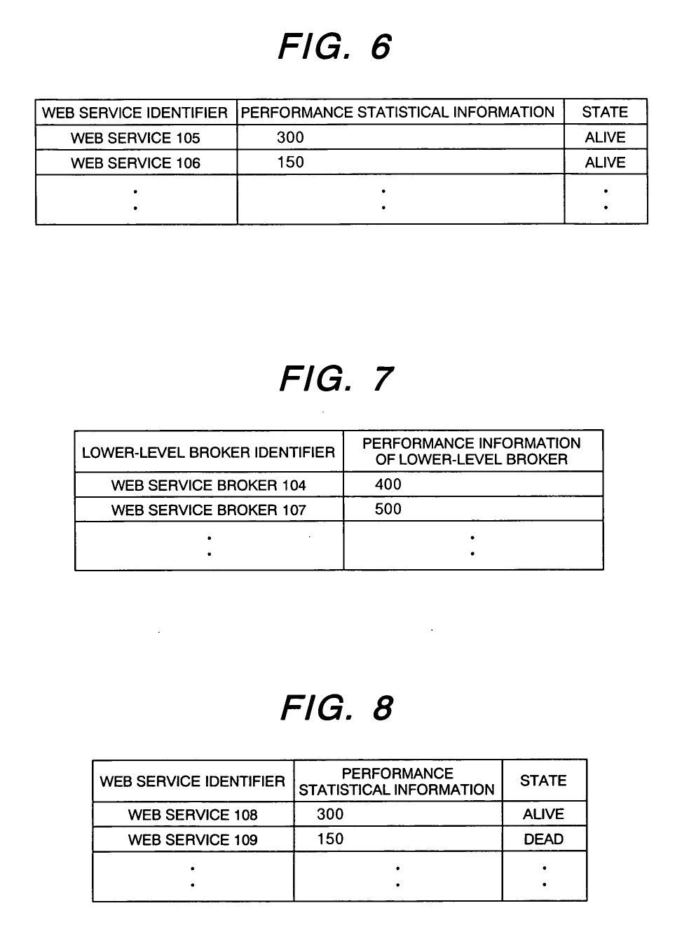

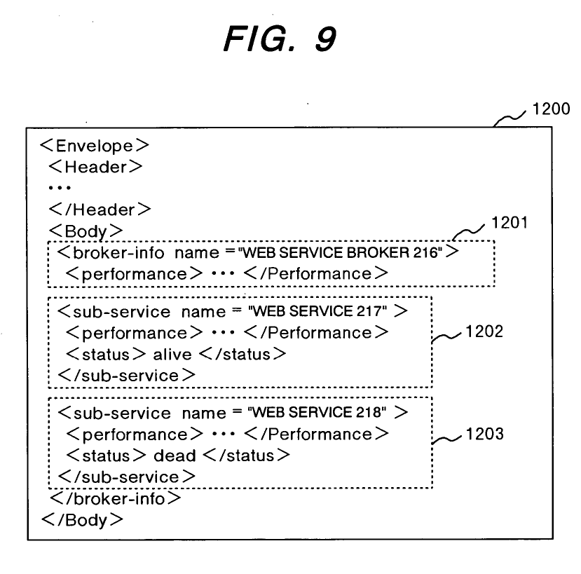

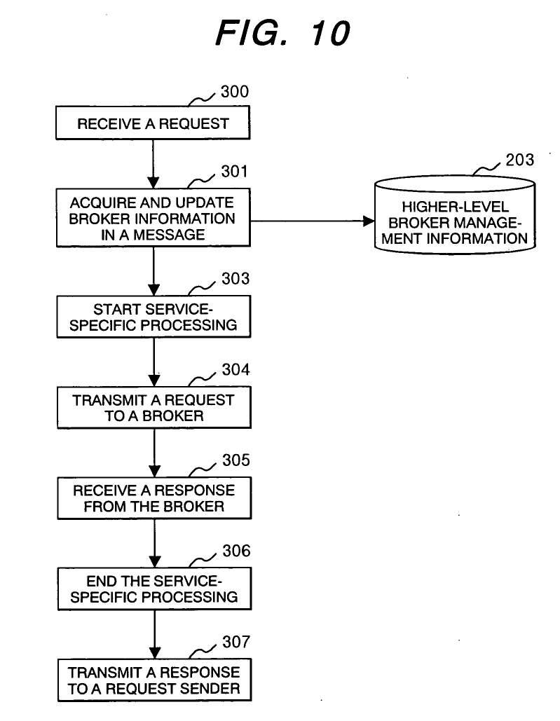

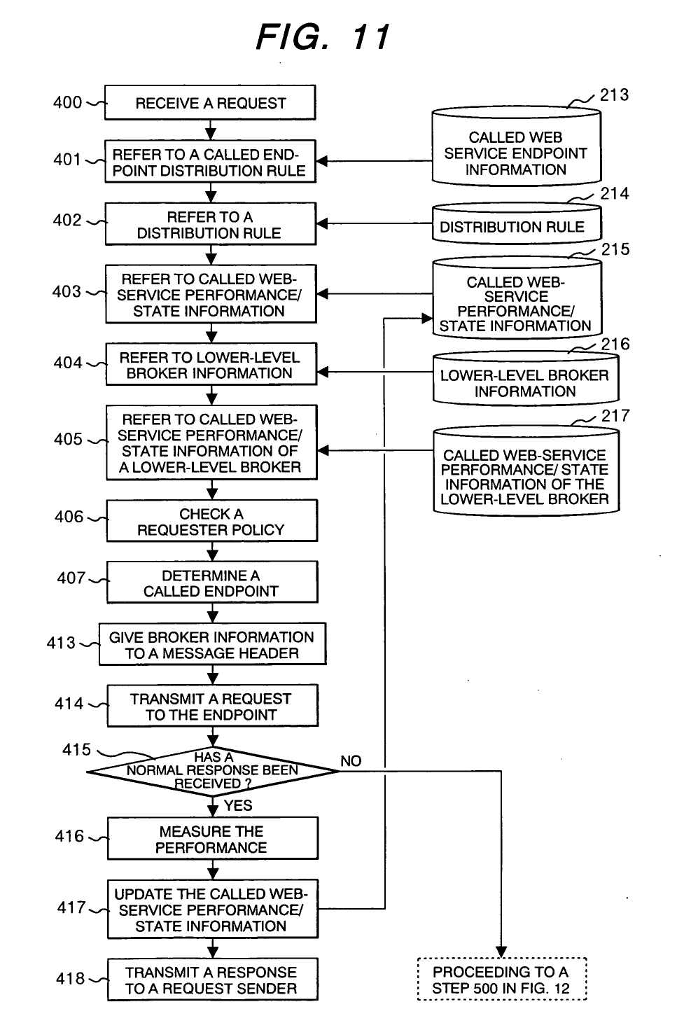

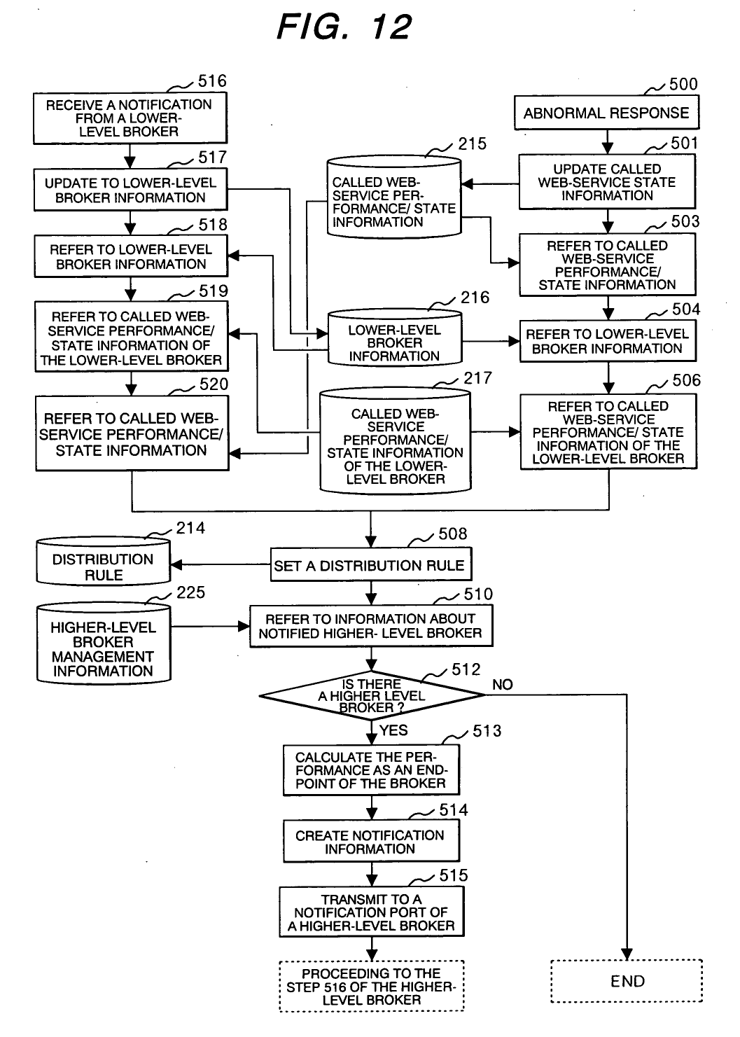

Embodiments according to the present invention will be described with reference to FIGS. 1 to 12 as below.

[Example of System Configuration]

First of all, a configuration of a service providing system according to one embodiment of the present invention will be described with reference to FIGS. 1 and 2.

FIG. 1 is a diagram illustrating the configuration of the service providing system according to one embodiment of the present invention.

In the service providing system shown in FIG. 1, with a Web service requestor which issues request messages to make use of services being used as a root, Web service providers which provide services (hereinafter, in the specification and the diagrams, the Web service provider is merely referred to as “Web service”), and Web service brokers, each of which plays an intermediary role between the Web service requestor and the Web service provider with respect to request messages, are placed on a tree. The Web service requestor and the Web service providers are coupled to one another through, for example, a TCP/IP network.

What is assumed in this embodiment is a case where when a Web service for providing services is called from the Web service requestor, the called Web service further calls another sub-Web service, and what is more, there are a plurality of sub-Web services for providing the same functions. In this case, a Web service broker placed therebetween determines a destination sub-Web service to which a request message is to be transmitted.

In FIG. 1, a Web service requestor 100 transmits a request message to a Web service broker 101. After that, the Web service broker 101 selects a Web service 102 or a Web service 103 on the basis of a defined distribution rule, and then transmits the request message to the selected Web service. Moreover, the Web service 102 newly calls a Web service broker 104. Then, the Web service broker 104 selects a destination to which the request message should be transmitted, from between a Web service 105 and a Web service 106. It is to be noted that although the Web service broker calls a Web service in FIG. 1, there is a case where another Web service broker may also be directly called.

Here, there is a case where the service requestor 100 is a browser operated by end users or a client program for transmitting a request message and for receiving a response message, or a Web service called by other Web service requestors. To be more specific, from the viewpoint of lower-level Web services that are called, a Web service which provides services also plays a role as a service requestor.

The Web services 102 and 103 are Web services that provide the same functions. Accordingly, regardless of which specific Web service is actually used, the Web service requestor 100 only transmits a request message to an endpoint that is opened to the public by the Web service broker 101. In like manner, the Web services 105 and 106 are also Web services that provide the same functions. Accordingly, regardless of which Web service is used, the Web service 102 transmits a request message for calling a sub-Web service to an endpoint that is opened to the public by the Web service broker 104.

In this embodiment, for example, if the Web service 109 enters an unusable state, the Web service broker 107 notifies (110) the Web service broker 101 of a change in performance of the Web service broker 107, a change in configuration including sub-Web services, and the like, which are caused as a result of the unusable state of the Web service 109, so that the notification is reflected in a request message distribution rule between the Web services 102 and 103 by the Web service broker 101. This makes it possible to determine a request-message destination from which a quicker response to the change in sub-Web service can be achieved.

Next, how a Web service and a Web service broker are configured will be described with reference to FIG. 2.

FIG. 2 includes diagrams illustrating how a Web service and a Web service broker are configured respectively.

Here, what is expressed as a Web service includes: a Web-service implementation program for implementing service-specific processing; and a Web-service execution engine that provides a SOAP message transmit/receive function, a called-service determination function, and the like, which are used when executing the Web-service implementation program.

In general, a plurality of Web-service implementation programs are deployed on one Web-service execution engine. A Web-service implementation program of a called Web service is determined on the basis of a destination endpoint of a request message, contents of the message, and the like, and then service-specific processing is executed.

As shown in FIG. 2, the Web service 200 comprises a request receiving server part 201, a request message processing part 202, a called service determination part 204, a service-specific processing part 205, and a request transmission client part 206. The Web service 200 has higher-level broker management information 203 as data.

The request receiving server part 201 is a part that receives a request message from a Web service requestor. The request message processing part 202 is a part that acquires information about a higher-level Web service broker included in a received request message, and that updates the higher-level broker management information 203. The called service determination part 204 is a part that determines a called Web service if there are a plurality of called Web services. The service-specific processing part 205 is a part that executes processing specific to the Web service so as to provide a service. The request transmission client part 206 is a part that transmits a received request message to a lower-level Web service broker.

In addition, the higher-level broker management information 203 includes information used to manage a service broker superordinate to the Web service as shown in FIG. 1.

As shown in FIG. 2, the Web service broker 210 comprises a request receiving server part 211, a called endpoint determination part 212, a request message processing part 218, a request transmission client part 219, a distribution-rule determination part 220, a transmission part 221 for transmitting a notification between brokers, a processing part 223 for processing notification information between brokers, a performance calculation part 222, and a receiving part 224 for receiving a notification between brokers. The Web service broker 210 comprises, as data, lower-level broker information 216, called Web-service endpoint information 213, a distribution rule 214, called Web-service performance/state information 217 of a lower-level broker, called Web-service performance/state information 215, and higher-level broker management information 225.

The request receiving server part 211 is a part that receives a request message from a higher-level Web service. The called endpoint determination part 212 is a part by which this Web service broker determines an endpoint to be called. The request message processing part 218 is a part that adds Web-service-broker information about this Web service broker to a received request message. The request transmission client part 219 is a part that transmits a request message to an endpoint that is determined as a called endpoint. The distribution-rule determination part 220 is a part that determines a new distribution rule on the basis of information received from a lower-level Web service broker so that the new distribution rule is set as the distribution rule 214. The transmission part 221 for transmitting a notification between brokers is a part that transmits, to a higher-level Web service broker, created information about notification between brokers. The processing part 223 for processing notification information between brokers is a part that creates notification information to be transmitted to a higher-level Web service broker. The performance calculation part 222 is a part that calculates an estimated value of the performance of this Web service broker with reference to information about a lower-level Web service broker, and the like. The receiving part 224 for receiving a notification between brokers is a part that receives notification information from a lower-level Web service broker.

The lower-level broker information 216 is information about a Web service broker subordinate to this Web service broker. The called Web-service endpoint information 213 is information about a Web service endpoint called from this Web service broker. The distribution rule 214 is a rule used to determine a Web service endpoint called from this service broker. The called Web-service performance/state information 215 is called Web-service performance/state information that is viewed from this Web service broker. The called Web-service performance/state information 217 of a lower-level broker is called Web-service performance/state information that is viewed from a lower-level broker subordinate to this Web service broker. The higher-level-broker management information 225 is information that is the same as the higher-level broker management information 203 stored in the Web service. Accordingly, the higher-level broker management information 225 may also be passed to the Web service broker 210 from the Web service 200 by means of file transfer, or may also be shared by a file server for data sharing so that this higher-level broker management information can be referred to from both of the Web service 200 and the Web service broker 210. Moreover, the Web service 200 may extract the higher-level broker management information to include the higher-level broker management information in a request message to be transmitted so that the request message including the higher-level broker management information is passed to the Web service broker 210.

[Data Structure]

Next, a data structure of a service providing system according to the present invention will be described in detail with reference to FIGS. 3 to 9.

FIG. 3 is a diagram illustrating an example of the higher-level broker management information 203.

FIG. 4 is a diagram illustrating an example of Web-service-broker information included in a request message.

FIG. 5 is a diagram illustrating an example of the called Web-service endpoint information 213.

FIG. 6 is a diagram illustrating an example of the called Web-service performance/state information 215.

FIG. 7 is a diagram illustrating an example of the lower-level broker information 216.

FIG. 8 is a diagram illustrating an example of the called Web-service performance/state information 217 of a lower-level broker

FIG. 9 is a diagram illustrating an example of notification message between brokers.

As shown in FIG. 3, the higher-level broker management information 203 has information including: an identifier of a Web service broker as a request-message sender (higher-level Web service broker); URL of an endpoint of a notification port; link information to an interface definition file of the notification port; and URL of an endpoint at which a request message from a higher-level Web service broker has been received.

As shown in FIG. 4, Web-service-broker information is included in a request message. A request message 700 shown in FIG. 4 is a SOAP message, and includes Web-service-broker information 701.

The called Web-service endpoint information 213 includes information about endpoints of Web services called from a Web service broker. As shown in FIG. 5, the called Web-service endpoint information 213 has URLs of receive endpoints and URLs of destination endpoints.

This called Web-service endpoint information 213 is used to manage a group of URLs of destination Web service endpoints, with respect to a URL of an endpoint at which a Web service broker has received a request message, so that a destination of a request message received by a Web service broker is determined.

The called Web-service performance/state information 215 represents performance/state information of a called Web service that is viewed from a Web service broker. As shown in FIG. 6, the called Web-service performance/state information 215 includes an identifier of a Web service, performance statistical information of the Web service, and state information of the Web service. Here, the performance statistical information is information expressed in terms of, for example, the number of request processing per unit time. The state information is information expressed in terms of, for example, “Alive” representing an usable state (normal state), “Dead” representing an unusable state (abnormal condition), and the like.

The lower-level broker information 216 is information about a Web service broker subordinate to this Web service broker. As shown in FIG. 7, the lower-level broker information 216 includes an identifier of a lower-level Web service broker, and performance information of the lower-level Web service broker. The lower-level broker information can be acquired by notification information from a lower-level Web service broker.

The called Web-service performance/state information 217 of a lower-level broker is called Web-service performance/state information that is viewed from a lower-level broker. As shown in FIG. 8, the called Web-service performance/state information 217 of a lower-level broker includes a Web service identifier, performance statistical information of a Web service, and state information. The above information can be acquired by notification information from a lower-level Web service broker.

The notification message between brokers is a message that is exchanged between Web service brokers. The notification message between brokers has a structure as shown in FIG. 9. The notification message between brokers 1200 shown in FIG. 9 is a SOAP message. Reference numeral 1201 denotes an identifier of a Web service broker that transmits notification information, and also denotes an estimated value of the performance. Each of reference numerals 1202, 1203 denotes information about a called Web service of a Web service broker that transmits notification information. Each of the information 1202, 1203 includes an identifier of a Web service broker, performance information, and a state.

[Processing of a Web-Service Providing System]

Next, processing steps of a service providing system according to one embodiment of the present invention will be described with reference to FIGS. 10 to 12.

FIG. 10 is a flowchart illustrating processing steps of a Web service.

FIGS. 11 and 12 are flowcharts illustrating processing steps of a Web service broker.

First of all, what will be described according to the flowchart in FIG. 10 is a sequence of processing steps from a step of receiving by a Web service a request message for a Web service to a step of transmitting a response message.

Operation of the Web service 102 shown in FIG. 1 will be described as below. To be more specific, the Web service 200 in FIG. 2 corresponds to the Web service 102 in FIG. 1.

First of all, the request receiving server part 201 of the Web service 200 receives a request message from a Web service requestor (step 300).

According to FIG. 1, the Web service requestor corresponds to the Web service broker 101.

The request message processing part (broker information extraction part) 202 acquires information about a higher-level Web service broker included in the request message shown in FIG. 4, and then updates the higher-level broker management information 203 (step 301). The structure of the higher-level broker management information 203 was shown in FIG. 3.

Next, the called service determination part 204 selects a called Web service if there are a plurality of called Web services. Then, the service-specific processing part 205 of the selected Web service starts a series of processing specific to the Web service in question (step 303).

Paying attention to the series of service-specific processing, there is a case where some functions may be achieved by calling other Web services. In such a case, with the object of calling other Web services during the series of service-specific processing, request-message transmission processing is newly performed.

At this time, the request transmission client part 206 transmits a request message to a Web service broker (step 304).

Next, the request transmission client part 206 receives from the Web service broker a response message corresponding to the transmitted request message (step 305). The service-specific processing part 205 creates a response message that is used to respond to the request-message sender, and then ends the service-specific processing (step 306).

After that, the request receiving server part 201 transmits the response message to the request-message sender (step 307).

Next, what will be described according to the flowchart in FIG. 11 is a sequence of processing steps from a step of receiving by a Web service broker a request message to a step of transmitting a response message.

Operation of the Web service broker 104 shown in FIG. 1 will be described as below. To be more specific, the Web service broker 210 in FIG. 2 corresponds to the Web service 104 in FIG. 1.

First of all, the request receiving server part 211 of the Web service broker 210 receives a request message from the Web service 102 (step 400).

In the called endpoint determination part 212, steps 401 through 407 are executed.

First of all, the called endpoint determination part 212 acquires information about a called endpoint from the called Web-service endpoint information 213 (step 401). The structure of the called Web-service endpoint information 213 was shown in FIG. 5.

Next, the called endpoint determination part 212 acquires a distribution rule of the request message from the distribution rule 214 (step 402).

Next, the called endpoint determination part 212 acquires performance information of the called Web-service performance/state information 215 (410) (step 403). The structure of the called Web-service performance/state information 215 was shown in FIG. 6.

Next, the called endpoint determination part 212 acquires information about a lower-level broker from the lower-level broker information 216 (step 404). The structure of the lower-level broker information 216 was shown in FIG. 7.

Next, the called endpoint determination part 212 acquires called Web-service performance/state information of the lower-level broker from the called Web-service performance/state information 217 of the lower-level broker (step 405). The structure of the called Web-service performance/state information 217 of the lower-level broker was shown in FIG. 8. Next, the called endpoint determination part 212 acquires and checks a policy (requestor policy) of a user (requestor) who has first created and transmitted the request message (step 406).

The request message includes information used to identify a requestor. The requestor policy is acquired by making use of an external policy retrieval service. In another case, for example, the requestor policy is acquired by including the requestor policy in the message. The requestor policy includes various kinds of information about conditions required when a requestor makes use of a Web service.

Next, on the basis of the result of checking the called Web-service performance/state information 215, the lower-level broker information 216, the called Web-service performance/state information 217 of a lower-level broker, and the requestor policy, the called endpoint determination part 212 selects, according to the distribution rule 214, a destination of a request message from among endpoints acquired from the called Web-service endpoint information 213 (step 407).

For example, if what is set as the distribution rule is a method in which a request message is transmitted by priority to a Web service, the performance of which is higher, a request message is distributed on the basis of performance statistical information of the Web services 105 and 106, said performance statistical information being measured by the Web service broker 104.

The request message processing part (broker information providing part) 218 adds Web-service-broker information of the Web service broker in question to the request message (step 413). The state in which the Web-service-broker information is added to the request message was shown in FIG. 4.

The request transmission client part 219 transmits the request message to the selected endpoint (step 414).

Then, if the request transmission client part 219 receives a normal response from the request message destination endpoint (step 415), the performance (for example, the response time) of the called Web service is measured (step 416), and performance information about the Web service in question of called Web-service performance/state information 215 is updated (step 417).

Lastly, the request receiving server part 211 transmits the received response message to the request-message sender (step 418).

Next, what will be described according to the flowchart in FIG. 12 is processing performed when an abnormality occurs in the Web service 105 that is called by the Web service broker 104 (210).

If an abnormal response is received, for example, if an error response message indicating an unusable state of the called Web service is received, or if the timeout occurs (step 500), the request transmission client part 219 of the Web service broker 104 (210) updates a state of the Web service in question of the called Web-service performance/state information 215 so that the state is changed to “dead” (step 501).

The distribution-rule determination part 220 acquires called Web-service performance/state information from the called Web-service performance/state information 215 (step 503).

Next, the distribution-rule determination part 220 acquires performance information of the lower-level broker from the lower-level broker information 216 (step 504).

Next, the distribution-rule determination part 220 acquires called Web-service performance/state information of the lower-level broker from the called Web-service performance/state information 217 of the lower-level broker (step 506).

Next, by use of information acquired from the called Web-service performance/state information 215, the lower-level broker information 216, and the called Web-service performance/state information 217 of the lower-level broker, the distribution-rule determination part 220 determines a new distribution rule, and then sets the new distribution rule as the distribution rule 214 (step 508).

The processing part 223 for processing notification information between brokers acquires, from the higher-level broker management information 225, information about a Web service broker to which notification information is to be transmitted (step 510). The higher-level broker management information 203 of the Web service is reflected in this higher-level broker management information 225.

After that, a check is made as to whether or not there is a higher-level Web service broker (step 512). If there is a higher-level Web service broker, the process proceeds to a step 513. If there is not a higher-level Web service broker, the process ends.

If there is a higher-level Web service broker, the performance calculation part 222 calculates an estimated value of the performance of the Web service broker by use of information acquired from the called Web-service performance/state information 215 (502), the lower-level broker information 216 (505), and the called Web-service performance/state information 217 of the lower-level broker (507), and by use of the distribution rule 214 (509) (step 513).

For example, on the assumptions that the performance of the Web service 105 is the same as that of the Web service 106, and that the number of request messages distributed to the Web service 105 by the Web service broker 104 is the same as that distributed to the Web service 106, if the Web service 106 enters the unusable state, the performance as an endpoint at which the Web service broker 104 receives requests from the Web service 102 is estimated at a half of the performance before entering the unusable state.

The processing part 223 for processing notification information between brokers creates notification information to be transmitted to the higher-level Web service broker (step 514).

The transmission part 221 for transmitting a notification between brokers then transmits the created notification information to the Web service broker 101 that is a higher-level Web service broker (step 515).

Next, what will be described according to the flowchart in FIG. 12 is processing of the Web service broker 101 (210) that has received notification information from the Web service broker 104 that is subordinate to the Web service broker 101 (210).

The receiving part 224 for receiving a notification between brokers of the Web service broker 101 (210) receives notification information from the Web service broker 104 by use of the notification message between brokers 1200 shown in FIG. 9 (step 516).

The processing part 223 for processing notification information between brokers writes, to the lower-level broker information 216, the lower-level broker information acquired from the notification information (step 517).

The distribution-rule determination part 220 acquires lower-level broker information from the lower-level broker information 216 (step 518).

Next, the distribution-rule determination part 220 acquires called Web-service performance/state information of the lower-level Web service from the called Web-service performance/state information 217 of the lower-level broker (step 519).

Next, the distribution-rule determination part 220 acquires performance/state information of each called Web service from the called Web-service performance/state information 215 (step 520).

Next, by use of information acquired from the called Web-service performance/state information 215, the lower-level broker information 216, and the called Web-service performance/state information 217 of the lower-level broker, the distribution-rule determination part 220 determines a new distribution rule, and then sets the new distribution rule as the distribution rule 214 (step 508).

What will be considered is, for example, a case where because the performance of the Web service 102 is higher than that of the Web service 103 before receiving the notification information from the lower-level Web service broker 104, a rule by which request messages are distributed to the Web service 102 by priority is applied. If it is notified by the lower-level Web service broker 104 that an estimated value of the performance of the Web service broker is reduced to a half due to system down of the Web service 105, it can be judged that the performance at the time of transmitting requests to the Web service 103 exceeds the performance at the time of transmitting requests to the Web service 102. Accordingly, a rule by which request messages are distributed to the Web service 103 by priority is set as a new distribution rule.

In addition, what will be considered is, for example, a case where before notification information is received from the lower-level Web service broker 104, the performance of the Web services 105 and 106 is the same as that of the Web services 108 and 109, and where 1:1 is set as a request-message distribution ratio of the Web service broker 101. If it is notified by the lower-level Web service broker 104 that the Web service 106 has entered the unusable state, a rule by which request messages are distributed to the Web services 102 and 103 in a ratio of 1:2 is set as a new distribution rule.

The Web service broker which has received the notification information from the lower-level Web service broker can determine a new distribution rule with various kinds of information (an estimated value of the performance at an endpoint of the Web service broker, called Web-service performance/state information of the lower-level broker, and the like) included in the notification information being freely combined with one another.

As another method, what is made use of as a temporary rule is a distribution rule that is newly given to the Web service broker by use of information that is notified by the lower-level Web service broker as a result of a change in performance, a change in state, and a change in configuration, of the lower-level Web service. After a lapse of a fixed period of time, the distribution rule based on the statistical performance information of the called Web service is used again as before.

If the above method is used, when a change in state occurs, the performance needs to be measured for a fixed period of time until the influence of the change in state is reflected in the performance statistical information. Accordingly, by applying, for that period of time, a rule based on the estimated value calculated in consideration of the influence of the change in state, it is possible to determine a request-message destination from which a quicker response to the change in state can be achieved.

Here, processing steps from the step 510 shown in FIG. 12, after the distribution-rule setting 508, are similar to those described above.

[Settings of Requestor Policy in Web Service]

Here, what will be considered is a case where as a requestor policy, the Web service 109 is specified as a Web service which a requestor does not want to make use of.

What is assumed here is a case where the Web service 108 enters an unusable state due to system down, and accordingly the Web service broker 107 transmits notification information to the higher-level Web service broker 101.

At this time, if the Web service broker 101 selects the Web service 103 as a destination of a request message, the Web service broker 101 can know, on the basis of the notification information from the lower-level Web service broker 107, that the lower-level Web service 109 is inevitably used. Accordingly, the Web service broker 101 can transmit a request message to the Web service 102 so as to satisfy the policy.

Heretofore, in a stage of determining a request-message destination of the Web service broker 107, it is judged that there is no request-message destination satisfying a requestor policy. Therefore, the processing is performed by tracing information back to a higher-level branch, or a request message is forced to be retransmitted from the beginning due to the occurrence of an error. However, according to the present invention, because information about lower-level Web services is kept track of at a higher-level branch, it is possible to eliminate such unnecessary processing.

Having described a preferred embodiment of the invention with reference to the accompanying drawings, it is to be understood that the invention is not limited to the embodiments and that various changes and modifications could be effected therein by one skilled in the art without departing from the spirit or scope of the invention as defined in the appended claims.

What is claimed is:

1. A request message control method used in a service providing system, said service providing system having:
a service requester for transmitting a request message to utilize services;
a plurality of service providers that receive the request message, and that provide the same services on the-basis of the message; and
a service broker that receives the request message, and that transmits the message to any one of the service providers or another service broker;
and which are coupled by a network, wherein:
said service requestor, said service broker, and said service providers are coupled so as to have a tree structure;
said service providing system successively transmits request messages, which are issued by the service requestor corresponding to a root of the tree structure, to a subordinate service broker and a subordinate service provider; and
with reference to performance information, and state information, of service providers subordinate to the service broker, and with reference to information about the relationship of the service broker in the tree structure, the service broker selects the subordinate service broker or the subordinate service provider, and then transmits a request message, which is transmitted from a superordinate service provider in the tree structure, to the selected service broker or the selected service provider.

2. A request message control method according to claim 1, wherein:
said service broker gives, as a notification, performance information, and state information, of service providers subordinate to the service broker, and information about the relationship of the service broker in the tree structure, to a service broker superordinate to the service broker in question.

3. A request message control method according to claim 1, wherein:
on the basis of the performance information, and the state information, of the service providers, which have been given as the notification by the subordinate service broker, and on the basis of the information about the relationship of the subordinate service broker in the tree structure, said service broker calculates an estimated value of the performance of services achieved when a request message is transmitted to the subordinate service broker, and then notifies a service broker superordinate to the service broker in question of the calculated estimated value of the performance; and
said service broker, which has been notified of the estimated value of the performance, selects the subordinate service broker or the subordinate service provider with reference to the notified estimated value of the performance, and then transmits the request message, which is transmitted from the superordinate service provider in the tree structure, to the selected service broker or the selected service provider.

4. A request message control method according to claim 1, wherein:
said service broker refers to a requestor policy used to provide the service requestor with services, and if there are a plurality of subordinate service providers that provide the same services, said service broker selects the subordinate service broker or the subordinate service provider on the basis of the requestor policy.

5. A request message control method according to claim 4, wherein:
said requestor policy includes a description of a service provider which the service requestor does not want to utilize, and said service broker selects the subordinate service broker or the subordinate service provider so that the request message is not transmitted in a direction of a subtree including the service provider which the service requestor does not want to utilize.

6. A service providing system having:
a service requestor for transmitting a request message to utilize services;
a plurality of service providers that receive the request message, and that provide the same services on the basis of the message; and
a service broker that receives the request message, and that transmits the message to any one of the service providers or another service broker;
and which are coupled after tree structure by a network, wherein
request messages, which are issued by the service requestor corresponding to a root of the tree structure, are successively transmitted to a subordinate service broker and a subordinate service provider; and
said service broker has a function of, with reference to performance information, and state information, of service providers subordinate to the service broker, and with reference to information about the relationship of the service broker in the tree structure, selecting the subordinate service broker or the subordinate service provider, and then transmitting the request message, which is transmitted from a superordinate service provider in the tree structure, to the selected service broker or the selected service provider.

7. A service providing system according to claim 6, wherein:
said service broker has a function of giving, as a notification, performance information, and state information, of service providers subordinate to the service broker, and information about the relationship of the service broker in the tree structure, to a service broker superordinate to the service broker in question.

8. A service providing system according to claim 6, wherein:
said service requester, said service provider, and said service broker are a Web service requestor, a Web service provider, and a Web service broker respectively.
